(19) United States
(12) Patent Application Publication
(10) Pub. No.: US 2025/0244996 A1
(43) Pub. Date: Jul. 31, 2025

(54) ON-BOARD SYSTEM, UPDATE CONTROL APPARATUS, AND PROGRAM UPDATE CONTROL METHOD

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventors: Hiroshi TATEISHI, Yokkaichi-Shi, Mie (JP); Ken FURUTO, Yokkaichi-shi, Mie (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/853,236

(22) PCT Filed: Mar. 17, 2023
(86) PCT No.: PCT/JP2023/010590

§ 371 Date: Oct. 1, 2024

(30) Foreign Application Priority Data
Apr. 4, 2022 (JP) 2022-062429

(51) Int. Cl. G06F 8/65

(52) U.S. Cl. CPC G06F 8/65

(57) ABSTRACT

An update control apparatus includes a reception unit that receives first partial data that is partial data of update data to be used in the update of a program; a storage unit in which the first partial data received by the reception unit is stored; and a transmission unit that transmits the first partial data stored in the storage unit to a target on-board apparatus so that the target on-board apparatus can generate the update data by combining the first partial data and second partial data transmitted from a selected on-board apparatus, wherein the selected on-board apparatus is an on-board apparatus in which the second partial data transmitted from the external apparatus is stored, the selected on-board apparatus being selected from among the plurality of non-target on-board apparatuses based on a selection condition for each of the plurality of on-board apparatuses.

### CROSS-REFERENCE TO RELATED APPLICATIONS

This application is the U.S. national stage of PCT/JP2023/010590 filed on Mar. 17, 2023, which claims priority of Japanese Patent Application No. JP 2022-062429 filed on Apr. 4, 2022, the contents of which are incorporated herein.

### TECHNICAL FIELD

The present disclosure relates to an on-board system, an update control apparatus, and a program update control method.

### BACKGROUND

Vehicles are equipped with on-board Electronic Control Units (ECUs) for controlling on-board devices, such as those of the power train system for controlling the engine, etc., and those of the body system for controlling the air conditioner, etc. JP 2021-015618A discloses an on-board update apparatus that, when updating a program of an on-board ECU, transmits an update program downloaded from an external server to the update-target on-board ECU after temporarily storing (caching) the update program in a storage unit. The on-board update apparatus disclosed in JP 2021-015618A secures a storage area for the update program by transmitting move-target data stored in the storage unit to the external server or a non-update-target on-board ECU before downloading the update program from the external server.

In some cases such as that in which the move-target data is essential for the operation of the on-board update apparatus, it is difficult to secure the storage area for the updated program by transmitting the move-target data.

### SUMMARY

An on-board system according to one aspect of the present disclosure includes: a target on-board apparatus that is an on-board apparatus in which a program is to be currently updated; a plurality of non-target on-board apparatuses that are each an on-board apparatus in which the program is not to be currently updated; and an update control apparatus that controls the update of the program in the target on-board apparatus, wherein the update control apparatus includes: a first reception unit that receives, from an external apparatus that is disposed outside a vehicle, first partial data that is partial data of update data to be used in the update of the program; a first storage unit in which the first partial data received by the first reception unit is stored; and a first transmission unit that transmits, to the target on-board apparatus, the first partial data stored in the first storage unit, a selected on-board apparatus selected from among the plurality of non-target on-board apparatuses includes: a second reception unit that receives, from the external apparatus, second partial data that is partial data of the update data and that is different from the first partial data; a second storage unit in which the second partial data received by the second reception unit is stored; and a second transmission unit that transmits, to the target on-board apparatus, the second partial data stored in the second storage unit, the target on-board apparatus includes: a third reception unit that receives the first partial data from the update control apparatus and receives the second partial data from the selected on-board apparatus; a generation unit that generates the update data by combining the first partial data and the second partial data received by the third reception unit; and an update unit that updates the program using the update data generated by the generation unit, and the selected on-board apparatus is selected from among the plurality of non-target on-board apparatuses based on a selection condition for each of the plurality of on-board apparatuses.

An update control apparatus according to one aspect of the present disclosure is an update control apparatus that controls the update of a program in a target on-board apparatus that is an on-board apparatus in which the program is to be currently updated, the update control apparatus including: a reception unit that receives, from an external apparatus that is disposed outside a vehicle, first partial data that is partial data of update data to be used in the update of the program; a storage unit in which the first partial data received by the reception unit is stored; and a transmission unit that transmits the first partial data stored in the storage unit to the target on-board apparatus so that the target on-board apparatus can generate the update data by combining second partial data transmitted from a selected on-board apparatus and the first partial data, the second partial data being partial data of the update data and being different from the first partial data, wherein the selected on-board apparatus is an on-board apparatus in which the second partial data transmitted from the external apparatus is stored, the selected on-board apparatus being selected from among the plurality of non-target on-board apparatuses based on a selection condition for each of the plurality of on-board apparatuses.

A program update control method according to one aspect of the present disclosure is a program update control method executed by an update control apparatus that controls the update of a program in a target on-board apparatus that is an on-board apparatus in which the program is to be currently updated, the program update control method including: a step in which the update control apparatus receives, from an external apparatus that is disposed outside a vehicle, first partial data that is partial data of update data to be used in the update of the program; a step in which the update control apparatus stores the received first partial data therein; and a step in which the update control apparatus transmits the stored first partial data to the target on-board apparatus so that the target on-board apparatus can generate the update data by combining second partial data transmitted from a selected on-board apparatus and the first partial data, the second partial data being partial data of the update data and being different from the first partial data, wherein the selected on-board apparatus is an on-board apparatus in which the second partial data transmitted from the external apparatus is stored, the selected on-board apparatus being selected from among the plurality of non-target on-board apparatuses based on a selection condition for each of the plurality of on-board apparatuses.

Not only can the present disclosure be realized as an update control apparatus including the characteristic configurations described above and an on-board system including the update control apparatus, but the present disclosure can also be realized as a program update control method including characteristic processing in the update control apparatus as steps, or as a program for causing the update control apparatus to execute the characteristic processing; furthermore, the update control apparatus can be realized, in part or entirely, as a semiconductor integrated circuit.

### Advantageous Effects

According to the present disclosure, update data can be downloaded without moving data in a storage unit of an update control apparatus to a different location even if there is not enough free space in the storage unit of the update control apparatus.

### BRIEF DESCRIPTION OF DRAWINGS

FIG. 1 is a schematic diagram for describing an example of a program update system according to an embodiment.

FIG. 2 is a block diagram illustrating an example of a configuration of an on-board system according to the embodiment.

FIG. 3 is a block diagram illustrating an example of a configuration of an OTA master according to the embodiment.

FIG. 4 is a block diagram illustrating an example of a configuration of ECUs according to the embodiment.

FIG. 5 is a functional block diagram illustrating an example of functions of the on-board system according to the embodiment.

FIG. 6 is a diagram for describing an example of weights and scores of items in a selection condition according to the embodiment.

FIG. 7 is a diagram for describing an example of a configuration of update data.

FIG. 8 is a diagram describing an example of splitting of the update data.

FIG. 9A is a diagram illustrating an example of a configuration of first update data.

FIG. 9B is a diagram illustrating an example of a configuration of second update data.

FIG. 10 is a sequence diagram for describing an example of memory-free-space check processing.

FIG. 11 is a sequence diagram for describing an example of split download processing.

FIG. 12 is a flowchart illustrating an example of selection processing.

FIG. 13 is a sequence diagram for describing an example of program update processing.

FIG. 14A is a flowchart illustrating part of an example of selection processing according to a modification.

FIG. 14B is a flowchart illustrating the rest of the example of the selection processing according to the modification.

### DETAILED DESCRIPTION OF PREFERRED EMBODIMENTS

An overview of embodiments of the present disclosure will be provided by listing and describing the embodiments.

In a first aspect, an on-board system according to the present embodiment includes: a target on-board apparatus that is an on-board apparatus in which a program is to be currently updated; a plurality of non-target on-board apparatuses that are each an on-board apparatus in which the program is not to be currently updated; and an update control apparatus that controls the update of the program in the target on-board apparatus, wherein the update control apparatus includes: a first reception unit that receives, from an external apparatus that is disposed outside a vehicle, first partial data that is partial data of update data to be used in the update of the program; a first storage unit in which the first partial data received by the first reception unit is stored; and a first transmission unit that transmits, to the target on-board apparatus, the first partial data stored in the first storage unit, a selected on-board apparatus selected from among the plurality of non-target on-board apparatuses includes: a second reception unit that receives, from the external apparatus, second partial data that is partial data of the update data and that is different from the first partial data; a second storage unit in which the second partial data received by the second reception unit is stored; and a second transmission unit that transmits, to the target on-board apparatus, the second partial data stored in the second storage unit, and the target on-board apparatus includes: a third reception unit that receives the first partial data from the update control apparatus and receives the second partial data from the selected on-board apparatus; a generation unit that generates the update data by combining the first partial data and the second partial data received by the third reception unit; and an update unit that updates the program using the update data generated by the generation unit. Thus, because a part of the update data is stored in the update control apparatus and another part of the update data is stored in the selected on-board apparatus, the update data can be downloaded without moving data in the storage unit of the update control apparatus to a different location even if there is not enough free space in the storage unit of the update control apparatus.

In a second aspect according to the first aspect, the selected on-board apparatus may be selected from among the plurality of non-target on-board apparatuses based on a selection condition for each of the plurality of on-board apparatuses. Thus, the selected on-board apparatus can be selected from the plurality of non-target on-board apparatuses in accordance with the selection condition.

In a third aspect, according to the second aspect, the selection condition may be a condition relating to at least one of a processing load of the on-board apparatus when the vehicle is in a driven state; a processing load of the on-board apparatus when a vehicle occupant is on board the vehicle; a security strength of the on-board apparatus; a communication accessibility of the on-board apparatus; a free space in a storage unit provided in the on-board apparatus; write and read speeds of the storage unit; and the number of logical constituent units in the storage unit included in the on-board apparatuses. Thus, the selected on-board apparatus can be selected appropriately based on the above-described conditions.

In a fourth aspect according to the third aspect, the on-board system may further include an external-communication apparatus that can communicate with the external apparatus, and the security strength of an on-board apparatus that is connected to a same bus as the external-communication apparatus may be lower than the security strength of an on-board apparatus that is connected to a bus that is different from the bus to which the external-communication apparatus is connected. Thus, the selected on-board apparatus can be selected appropriately in accordance with buses to which the on-board apparatuses are connected in the on-board system.

In a fifth aspect according to the third or the fourth aspects, the communication accessibility of an on-board apparatus that is connected to a same bus as the target on-board apparatus may be higher than the communication accessibility of an on-board apparatus that is connected to a bus that is different from the bus to which the target on-board apparatus is connected. Thus, the selected on-board apparatus can be selected appropriately in accordance with buses to which the on-board apparatuses are connected in the on-board system.

In a sixth aspect according to any one of the third through the fifth aspects, the number of logical constituent units in the storage unit included in the on-board apparatus may include a case in which the on-board apparatus includes a single-bank non-volatile memory and a case in which the on-board apparatus includes a double-bank non-volatile memory. Thus, the selected on-board apparatus can be selected appropriately in accordance with whether storage units included in the on-board apparatuses are single-bank memories or double-bank memories.

In a seventh aspect according to any one of the third through the sixth aspects, the update control apparatus may include: a selection unit that selects the selected on-board apparatus from among the plurality of non-target on-board apparatuses based on the selection condition; and a notification unit that notifies the external apparatus of the selected on-board apparatus selected by the selection unit. Thus, the update control apparatus, which is installed in a vehicle, can select the selected on-board apparatus.

In an eighth aspect according to a seventh aspect, the selection unit may assign, to each of the plurality of non-target on-board apparatuses, a score for at least one item among: the processing load of the on-board apparatus when the vehicle is in the driven state; the processing load of the on-board apparatus when a vehicle occupant is on board the vehicle; the security strength of the on-board apparatus; the communication accessibility of the on-board apparatus; the free space in the storage unit provided in the on-board apparatus; the write and read speeds of the storage unit; and the number of logical constituent units in the storage unit included in the on-board apparatus, and select the selected on-board apparatus from among the plurality of the non-target on-board apparatuses based on the score. Thus, the non-target on-board apparatuses can be quantitatively evaluated with respect to the above-described items, and the selected on-board apparatus can be selected appropriately in accordance with the result of the evaluation.

In a ninth aspect according to the eighth aspect, the selection unit may assign a weight to each of a plurality of items consisting of the processing load of the on-board apparatus when the vehicle is in the driven state; the processing load of the on-board apparatus when a vehicle occupant is on board the vehicle; the security strength of the on-board apparatus; the communication accessibility of the on-board apparatus; the free space in the storage unit provided in the on-board apparatus; the write and read speeds of the storage unit; and the number of logical constituent units in the storage unit included in the on-board apparatus, and select the selected on-board apparatus from among the plurality of the non-target on-board apparatuses based on a result obtained by multiplying the weight by the score. Thus, the non-target on-board apparatuses can be quantitatively evaluated in accordance with the degrees of importance of the above-described items, and the selected on-board apparatus can be selected appropriately in accordance with the result of the evaluation.

In a tenth aspect according to the seventh aspect, the selection condition may include a plurality of conditions relating to a plurality of items selected from among: the processing load of the on-board apparatus when the vehicle is in the driven state; the processing load of the on-board apparatus when a vehicle occupant is on board the vehicle; the security strength of the on-board apparatus; the communication accessibility of the on-board apparatus; the free space in the storage unit provided in the on-board apparatus; the write and read speeds of the storage unit; and the number of logical constituent units in the storage unit included in the on-board apparatus, and the selection unit may select the selected on-board apparatus by sequentially determining, with respect to the plurality of conditions, one or more on-board apparatuses that meet the concerned condition from among the plurality of non-target on-board apparatuses. Thus, by sequentially determining on-board apparatuses that meet the plurality of conditions, on-board apparatuses that are candidates of the selected on-board apparatus can be narrowed down.

In an eleventh aspect according to any one of the first through the tenth aspects, the first reception unit may receive, from the external apparatus, first update data that includes the first partial data and first verification data for verifying the first partial data, the update control apparatus may include a first verification unit that verifies the first partial data included in the first update data using the first verification data included in the first update data, the first transmission unit may transmit the first partial data to the target on-board apparatus if the verification of the first partial data by the first verification unit is successful, the second reception unit may receive, from the external apparatus, second update data that includes the second partial data and second verification data for verifying the second partial data, the selected on-board apparatus may include a second verification unit that verifies the second partial data included in the second update data using the second verification data included in the second update data, and the second transmission unit may transmit the second partial data to the target on-board apparatus if the verification of the second partial data by the second verification unit is successful. Thus, the first partial data and the second partial data can be verified individually.

In a twelfth aspect according to any one of the first through the eleventh aspects, the update data may include an updated program that is an updated version of the program, and program verification data to be used to verify the updated program, and the program verification data may be included in the first partial data or the second partial data. Thus, the updated program included in the update data obtained by combining the first partial data and the second partial data can be verified.

An update control apparatus according to the present embodiment is an update control apparatus that controls the update of a program in a target on-board apparatus that is an on-board apparatus in which the program is to be currently updated, the update control apparatus including: a reception unit that receives, from an external apparatus that is disposed outside a vehicle, first partial data that is partial data of update data to be used in the update of the program; a storage unit in which the first partial data received by the reception unit is stored; and a transmission unit that transmits the first partial data stored in the storage unit to the target on-board apparatus so that the target on-board apparatus can generate the update data by combining second partial data transmitted from a selected on-board apparatus and the first partial data, the second partial data being partial data of the update data and being different from the first partial data, wherein the selected on-board apparatus is an on-board apparatus in which the second partial data transmitted from the external apparatus is stored. Thus, because a part of the update data is stored in the update control apparatus and another part of the update data is stored in the selected on-board apparatus, the update data can be downloaded without moving data in the storage unit of the update control apparatus to a different location even if there is not enough free space in the storage unit of the update control apparatus.

A program update control method according to the present embodiment is a program update control method executed by an update control apparatus that controls the update of a program in a target on-board apparatus that is an on-board apparatus in which the program is to be currently updated, the program update control method including: a step in which the update control apparatus receives, from an external apparatus that is disposed outside a vehicle, first partial data that is partial data of update data to be used in the update of the program; a step in which the update control apparatus stores the received first partial data therein; and a step in which the update control apparatus transmits the stored first partial data to the target on-board apparatus so that the target on-board apparatus can generate the update data by combining second partial data transmitted from a selected on-board apparatus and the first partial data, the second partial data being partial data of the update data and being different from the first partial data, wherein the selected on-board apparatus is an on-board apparatus in which the second partial data transmitted from the external apparatus is stored. Thus, because a part of the update data is stored in the update control apparatus and another part of the update data is stored in the selected on-board apparatus, the update data can be downloaded without moving data in the storage unit of the update control apparatus to a different location even if there is not enough free space in the storage unit of the update control apparatus.

Embodiments of the present disclosure will be described in detail in the following with reference to the drawings. Note that at least some of the embodiments described in the following may be combined as appropriate.

### Program Update System

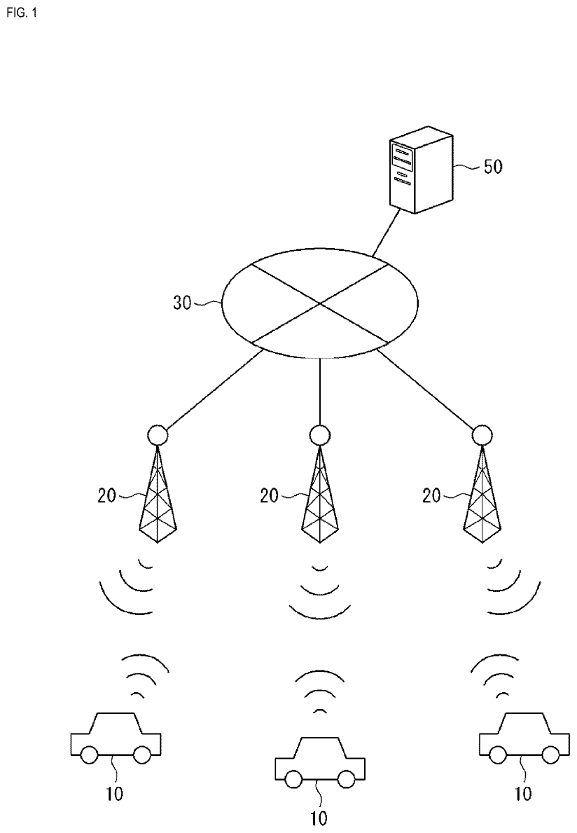

FIG. 1 is a schematic diagram for describing an example of a program update system according to the present embodiment.

The program update system is a system for updating control programs of on-board apparatuses installed in vehicles 10. The program update system includes the vehicles 10 and an Over-The-Air (OTA) server 50. The later-described on-board system is installed in each vehicle 10.

Each vehicle 10 can communicate with apparatuses outside the vehicle by wireless communication. For example, the vehicle 10 can wirelessly communicate with a base station 20 by being equipped with a wireless communication terminal conforming to the 5th Generation Mobile Communication System (5G) or the 4th Generation Mobile Communication System (4G). The base station 20 is connected to the Internet 30. The OTA server 50 is also connected to the Internet 30. As a result of such a configuration being adopted, the vehicle 10 and the OTA server 50 can mutually communicate.

The OTA server 50 can provide the vehicles 10 with data for updating programs. The OTA server 50 is an example of an “external apparatus”.

### On-Board System

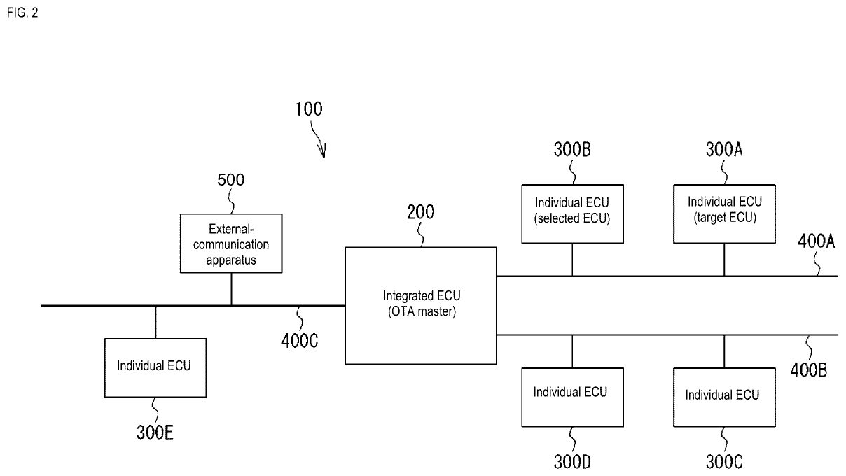

FIG. 2 is a block diagram illustrating an example of a configuration of an on-board system according to the present embodiment.

An on-board system 100 according to the present embodiment includes an integrated Electronic Control Unit (ECU) 200, and individual ECUs 300A, 300B, 300C, 300D, and 300E. The on-board system 100 is formed from the integrated ECU 200, the individual ECUs 300 (300A, 300B, 300C, 300D, and 300E), and communication cables (communication buses) connecting the ECUs.

The integrated ECU 200 is a gateway that relays the communication between multiple individual ECUs. The integrated ECU 200 is an OTA master that controls the update of control programs of the individual ECUs 300A, 300B, 300C, 300D, and 300E. The integrated ECU 200 is an example of an “update control apparatus”. Hereinafter, the integrated ECU 200 is also referred to as an “OTA master 200”.

The plurality of individual ECUs 300A, 300B, 300C, 300D, and 300E are disposed at respective portions of a vehicle 10. The individual ECUs 300A, 300B, 300C, 300D, and 300E individually control hardware at respective portions of the vehicle 10 or monitor the states of hardware at the respective portions of the vehicle 10. For example, the individual ECUs 300A, 300B, 300C, 300D, and 300E are ECUs of the power train system, the body system, and the information-and-entertainment system. The individual ECUs 300A, 300B, 300C, 300D, and 300E are examples of “on-board apparatuses”. Note that, in the following description, individual ECUs are also referred to as “ECUs”, and the individual ECUs 300A, 300B, 300C, 300D and 300E are collectively referred to as “ECUs 300”/“ECU 300”.

The OTA master 200 is connected to the ECUs 300A, 300B, 300C, 300D, and 300E via on-board buses 400A, 400B, and 400C, which are Controller Area Network (CAN) buses or the like. Specifically, the ECUs 300A and 300B are connected to the bus 400A. The ECUs 300C and 300D are connected to the bus 400B. The ECU 300E is connected to the bus 400C. The OTA master 200 can mutually communicate with each of the ECUs 300A, 300B, 300C, 300D, and 300E.

The OTA master 200 is connected to an external-communication apparatus 500 via the bus 400C. For example, the external-communication apparatus 500 is a wireless communication terminal conforming to 5G or 4G, and is a Telematics Control Unit (TSU), for example. The external-communication apparatus 500 can communicate with the OTA server 50. The external-communication apparatus 500 relays the communication between the OTA master 200 and the OTA server 50.

The bus 400C connected to the external-communication apparatus 500 is a vehicle-to-external communication bus that is used not only for communication within the vehicle but also for communication with apparatuses outside the vehicle. The buses 400A and 400B are in-vehicle communication buses that are used only for in-vehicle communication.

### Configuration of OTA Master

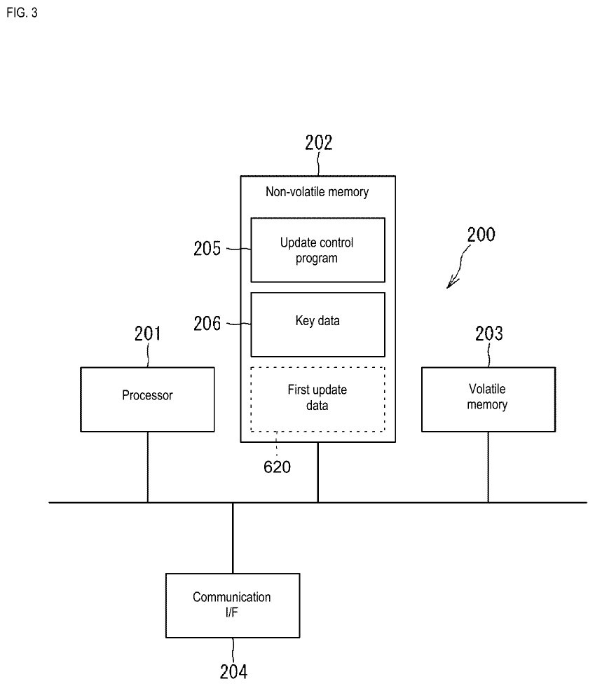

FIG. 3 is a block diagram illustrating an example of a configuration of the OTA master according to the present embodiment. The OTA master 200 includes a processor 201, a non-volatile memory 202, a volatile memory 203, and a communication interface (I/F) 204.

For example, the volatile memory 203 is a semiconductor memory such as a static random access memory (SRAM), a dynamic random access memory (DRAM), or the like. For example, the non-volatile memory 202 is a flash memory, a hard disk, or the like. Data can be read from and written to the non-volatile memory 202. An update control program 205, which is a computer program, and data to be used in the execution of the update control program 205 are stored in the non-volatile memory 202. The OTA master 200 can store first update data downloaded from the OTA server 50 in the non-volatile memory 202. The OTA master 200 is configured to include a computer, and the functions of the OTA master 200 are realized by the update control program 205, which is a computer program stored in a storage device of the computer, being executed.

The update control program 205 is a program for controlling the update of a control program of an ECU 300. Specifically, the update control program 205 is a program for selecting a storage destination of a part (second partial data) of update data of the control program from among the ECUs 300A, 300B, 300C, 300D, and 300E, and notifying the OTA server 50 of the selected ECU. The update control program 205 is a program for downloading the first update data including first partial data of the update data from the OTA server 50, storing the first partial data included in the downloaded first update data in the non-volatile memory 202, and transmitting the first partial data to a target ECU that is the ECU to be updated.

Key data 206 is stored in the non-volatile memory 202. The key data 206 is used to verify the update data (first update data) downloaded from the OTA server 50.

For example, the processor 201 is a central processing unit (CPU). However, the processor 201 is not limited to a CPU. The processor 201 may be a graphics processing unit (GPU). The processor 201 is configured to be capable of executing computer programs. However, for example, the processor 201 may include an application-specific integrated circuit (ASIC) in a part thereof, or may include a programmable logic device such as a field-programmable gate array (FPGA) in a part thereof.

For example, the communication I/F 204 is a communication interface conforming to the controller area network (CAN), which is a communication protocol for on-board networks. The communication I/F 204 may be a communication interface conforming to a protocol such as CAN with Flexible Data-Rate (CAN FD), Ethernet (registered trademark), or Local Interconnect Network (LIN). The communication I/F 204 includes a plurality of communication ports, and is connected to the buses 400A, 400B, and 400C. The communication I/F 204 is connected to the ECUs 300A, 300B, 300C, 300D, and 300E via the buses 400A, 400B, and 400C. The OTA master 200 can communicate with the ECUs 300A, 300B, 300C, 300D, and 300E by means of the communication I/F 204. Furthermore, by means of the communication I/F 204, the OTA master 200 can communicate with the OTA server 50 via the external-communication apparatus 500.

### OTA Server

The OTA server 50 is formed from a processor, storage devices (non-volatile memory and volatile memory), a communication I/F, etc. The OTA server 50 provides the ECU 300 with an updated version of the program (hereinafter “updated program”).

The OTA server 50 can download, to the OTA master 200, the update data, which is a package including the updated program and verification data (hereinafter “PG verification data”) to be used to verify the updated program. Upon receiving a request to split the update data from the OTA master 200, the OTA server 50 can generate the first partial data and the second partial data by splitting the update data, and individually download the first update data including the first partial data and the second update data including the second partial data.

### Configuration of ECUs

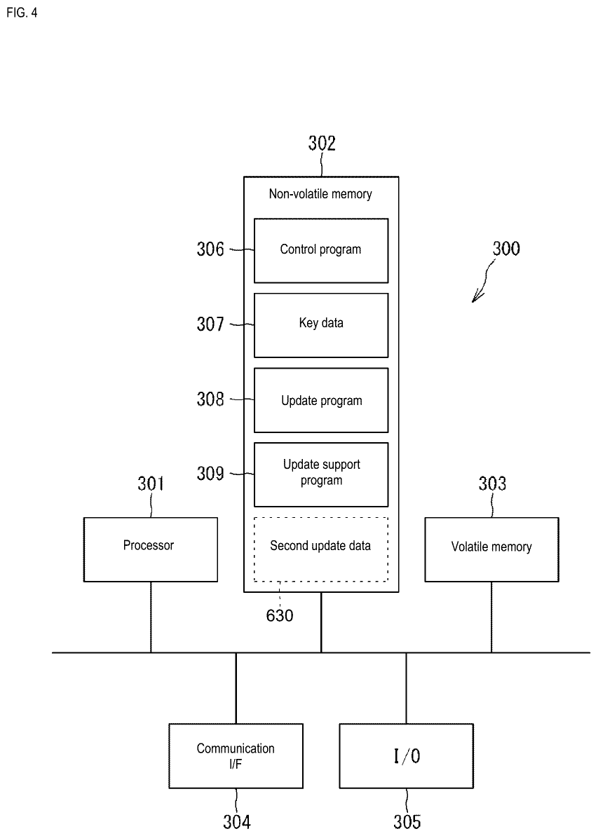

FIG. 4 is a block diagram illustrating an example of a configuration of the ECUs according to the present embodiment. The ECU 300 includes a processor 301, a non-volatile memory 302, a volatile memory 303, a communication I/F 304, and an input/output I/F (I/O) 305.

For example, the volatile memory 303 is a semiconductor memory such as an SRAM or DRAM. For example, the non-volatile memory 302 is a flash memory, a hard disk, a ROM, or the like. The non-volatile memory 302 is managed by a memory controller in units of banks each formed from one or more flash memory chips. That is, the banks are logical constituent units of the non-volatile memory 302. Each surface of a memory module constituting the non-volatile memory 302 defines a bank. A non-volatile memory 302 in which one or more flash memory chips are mounted on only one surface of a memory module is a single-bank memory, and a non-volatile memory 302 in which flash memory chips are mounted on both surfaces of a memory module is a double-bank memory. A control program 306, which is a computer program, and data to be used to execute the control program 306 are stored in the non-volatile memory 302. The individual ECU 300 is configured to include a computer, and the functions of the individual ECU 300 are realized by the control program 306, which is a computer program stored in a storage device of the computer, being executed. For example, the control program 306 is a program for controlling some hardware of the vehicle 10.

An update program 308 and data to be used to execute the update program 308 are stored in the non-volatile memory 302. The update program 308 is a program for receiving the update data from the OTA master 200 and updating the control program 306 using the received update data. Key data 307 is further stored in the non-volatile memory 302. The key data 307 is used to decode the PG verification data included in the update data.

Furthermore, an update support program 309 and data to be used to execute the update support program 309 are stored in the non-volatile memory 302. The update support program 309 is a program for receiving, via the OTA master 200, the second update data transmitted from the OTA server 50, storing the second partial data included in the received second update data to the non-volatile memory 302, and transmitting the second partial data to the target ECU.

For example, the processor 301 is a CPU. However, the processor 301 is not limited to a CPU. The processor 301 may be a GPU. For example, the processor 301 may include an ASIC in a part thereof, or may include a programmable logic device such as an FPGA in a part thereof.

For example, the communication I/F 304 is a communication interface conforming to CAN. The communication I/F 304 may be a communication interface conforming to a protocol such as CAN FD, Ethernet, or LIN. The communication I/F 304 includes at least one communication port, and is connected to one of the buses 400A, 400B, and 400C. The communication I/F 304 is connected to the OTA master 200 via one of the buses 400A, 400B, and 400C. The ECU 300 can communicate with the OTA master 200 by means of the communication I/F 304.

For example, the I/O 305 is connected to an unillustrated sensor or actuator. The I/O 305 can receive sensor data output from the sensor, or output a control signal to the actuator.

### Functions of On-Board System

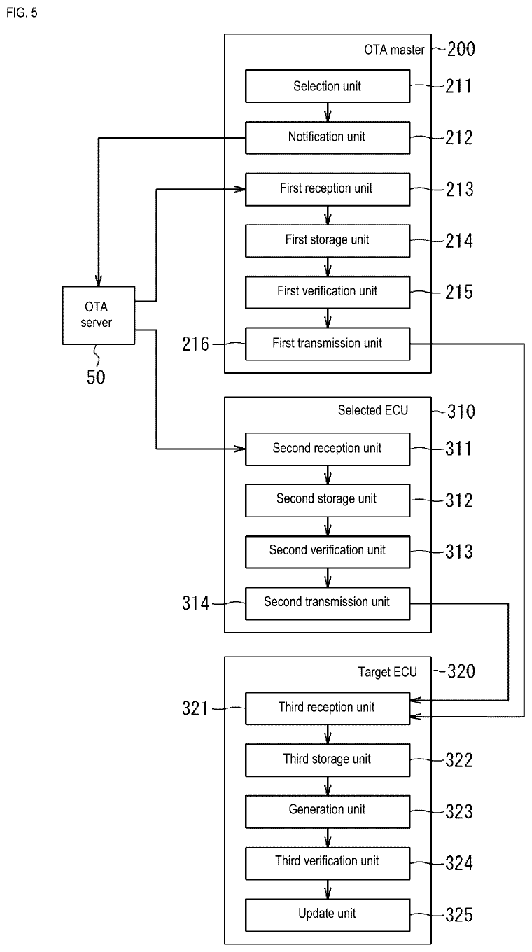

FIG. 5 is a functional block diagram illustrating an example of functions of the on-board system according to the present embodiment. In the following, an example will be described in which the control program 306 of the ECU 300A is updated, i.e., the ECU 300A is the target ECU, and the ECU 300B is selected as the storage destination of a part of the update data, i.e., the ECU 300B is the selected ECU. The target ECU is an example of a “target on-board apparatus”, and the selected ECU is an example of a “selected on-board apparatus”.

As a result of the processor 201 of the OTA master 200 executing the update control program 205, the functions of a selection unit 211, a notification unit 212, a first reception unit 213, a first storage unit 214, a first verification unit 215, and a first transmission unit 216 are realized. As a result of the processor 301 of a selected ECU 310 (the ECU 300B in the present example) among the ECUs 300A, 300B, 300C, 300D, and 300E executing the update support program 309, the functions of a second reception unit 311, a second storage unit 312, a second verification unit 313, and a second transmission unit 314 are realized. Furthermore, as a result of the processor 301 of a target ECU 320 (the ECU 300A in the present example) among the ECUs 300A, 300B, 300C, 300D, and 300E executing the update program 308, the functions of a third reception unit 321, a third storage unit 322, a generation unit 323, a third verification unit 324, and an update unit 325 are realized.

Based on a selection condition, the selection unit 211 selects the selected ECU 310 from among the ECUs 300B, 300C, 300D, and 300E (non-target on-board apparatuses) other than the ECU 300A, which is the target ECU 320. The selection condition is a condition for each of the plurality of ECUs 300B, 300C, 300D, and 300E. In a specific example, the selection condition is a condition relating to at least one of a processing load of the ECU 300 when the vehicle 10 is in a driven state; a processing load of the ECU 300 when a vehicle occupant is on board the vehicle 10; a security strength of the ECU 300; a communication accessibility of the ECU 300; the free space in the non-volatile memory 302 provided in the ECU 300; write and read speeds of the non-volatile memory 302; and the number of logical constituent units in the non-volatile memory 302 included in the ECU 300.

For example, the security strength of the ECU 300 is determined by the bus 400A, 400B, or 400C connected to the ECU 300. Specifically, the security strength of the ECU 300E connected to the vehicle-to-external communication bus 400C is lower than that of the ECUs, 300A, 300B, 300C, and 300D connected to the in-vehicle communication buses 400A and 400B.

For example, the communication accessibility of the ECU 300 is determined by the bus 400A, 400B, or 400C connected to the ECU 300. Specifically, the communication accessibility of the ECU 300B connected to the same bus 400A as the target ECU 320 is higher than the communication accessibility of the ECUs 300C, 300D, and 300E connected to the buses 400B and 400C different from the bus 400A, to which the target ECU 320 is connected.

For example, the ECU 300 is either an ECU including a single-bank storage unit or an ECU including a double-bank storage unit depending on the number of logical constituent units in the non-volatile memory 302 included in the ECU 300.

For example, the selection unit 211 assigns, to each of the ECUs 300B, 300C, 300D, and 300E, a score for at least one item among: the processing load of the ECU 300 when the vehicle 10 is in the driven state; the processing load of the ECU 300 when a vehicle occupant is on board the vehicle 10; the security strength of the ECU 300; the communication accessibility of the ECU 300; the free space in the non-volatile memory 302 provided in the ECU 300; the write and read speeds of the non-volatile memory 302; and the number of logical constituent units in the non-volatile memory 302 included in the ECU 300, and selects the selected ECU 310 from among the ECUs 300B, 300C, 300D, and 300E based on the score. In a specific example, the selection unit 211 assigns a weight to each of a plurality of items consisting of the processing load of the ECU 300 when the vehicle 10 is in the driven state; the processing load of the ECU 300 when a vehicle occupant is on board the vehicle 10; the security strength of the ECU 300; the communication accessibility of the ECU 300; the free space in the non-volatile memory 302 provided in the ECU 300; the write and read speeds of the non-volatile memory 302; and the number of logical constituent units in the non-volatile memory 302 included in the ECU 300, and selects the selected ECU 310 from among the ECUs 300B, 300C, 300D, and 300E based on a result obtained by multiplying the weight by the score.

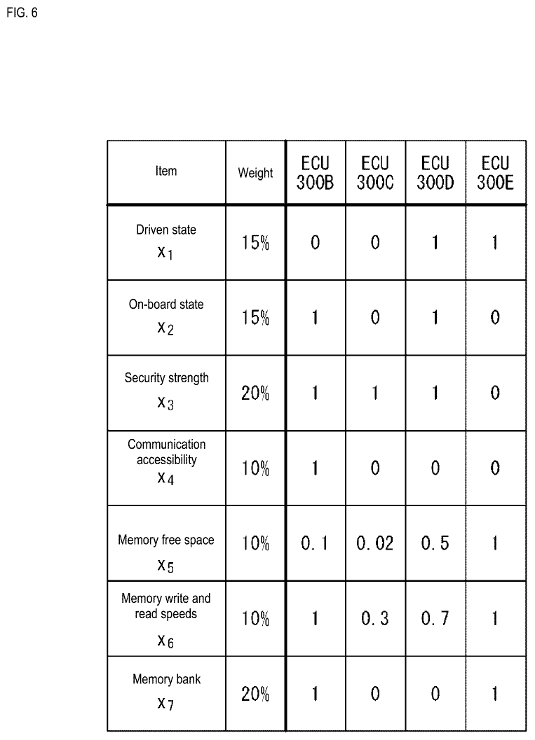

FIG. 6 is a diagram for describing an example of scores and weights assigned to items in the selection condition according to the present embodiment. In the example in FIG. 6, the weight assigned to the processing load (the item “driven state” in FIG. 6) x1 of the ECU 300 when the vehicle 10 is in the driven state is 15%. The score (value) for item x1 assigned to an ECU 300 having a high processing load when the vehicle 10 is being driven (hereinafter “driven state”) is 0, and the score for item x1 assigned to an ECU 300 having a low processing load in the driven state is 1. Specifically, because the ECUs 300B and 300C have a high processing load in the driven state, the score for item x1 assigned to the ECUs 300B and 300C is 0. Because the ECUs 300D and 300E have a low processing load in the driven state, the score for item x1 assigned to the ECUs 300D and 300E is 1.

The weight assigned to the processing load (the item “on-board state” in FIG. 6) x2 of the ECU 300 when a vehicle occupant is on board the vehicle 10 is 15%. The score (value) for item x2 assigned to an ECU 300 having a high processing load when a vehicle occupant is on board the vehicle 10 (hereinafter “on-board state”) is 0, and the score for item x2 assigned to an ECU 300 having a low processing load in the on-board state is 1. Specifically, because the ECUs 300C and 300E have a high processing load in the on-board state, the score for item x2 assigned to the ECUs 300C and 300E is 0. Because the ECUs 300B and 300D have a low processing load in the on-board state, the score for item x2 assigned to the ECUs 300B and 300D is 1.

The weight assigned to the security strength x3 of the ECU 300 is 20%. The score for item x3 assigned to an ECU 300 having a low security strength, i.e., the ECU 300E connected to the vehicle-to-external communication bus 400C, is 0, and the score for item x3 assigned to an ECU 300 having a high security strength, i.e., each of the ECUs 300B, 300C, and 300D connected to the in-vehicle communication buses 400A and 400B, is 1.

The weight assigned to the communication accessibility x4 of the ECU 300 is 10%. The score for item x4 assigned to an ECU 300 having a low communication accessibility, i.e., each of the ECUs 300C, 300D, and 300E connected to the buses 400B and 400C different from the bus 400A to which the target ECU 320 is connected, is 0, and the score for item x4 assigned to an ECU 300 having a high communication accessibility, i.e., the ECU 300B connected to the same bus 400A as the target ECU 320, is 1.

The weight assigned to the free space (the item “memory free space” in FIG. 6) x5 in the non-volatile memory 302 provided in the ECU 300 is 10%. A real number value corresponding to the free space in the non-volatile memory 302 is assigned as the score for item x5. For example, the score is calculated by: free space (MB) in non-volatile memory 302×0.01. However, 1 is assigned as the score if the result of the calculation based on this mathematical formula is greater than or equal to 1. In the example in FIG. 6, the score for item x5 assigned to the ECU 300B is 0.1 because the memory free space in the ECU 300B is 10 MB. The score for item x5 assigned to the ECU 300C is 0.02 because the memory free space in the ECU 300C is 2 MB. The score for item x5 assigned to the ECU 300D is 0.5 because the memory free space in the ECU 300D is 50 MB. The score for item x5 assigned to the ECU 300E is 1 because the memory free space in the ECU 300E is 150 MB.

The weight assigned to the write and read speeds (the item “memory write and read speeds” in FIG. 6) x6 of the non-volatile memory 302 provided in the ECU 300 is 10%. A real number value corresponding to the write and read speeds of the non-volatile memory 302 is assigned as the score for item x6. For example, the score is calculated by: write speed (kbps)×0.001+read speed (kbps)×0.001. However, 1 is assigned as the score if the result of the calculation based on this mathematical formula is greater than or equal to 1. In the example in FIG. 6, the score for item x6 assigned to the ECU 300B is 1 because the memory write speed and read speed of the ECU 300B are 500 kbps and 500 kbps, respectively. The score for item x6 assigned to the ECU 300C is 0.3 because the memory write speed and read speed of the ECU 300C are 100 kbps and 200 kbps, respectively. The score for item x6 assigned to the ECU 300D is 0.7 because the memory write speed and read speed of the ECU 300D are 200 kbps and 500 kbps, respectively. The score for item x6 assigned to the ECU 300E is 1 because the memory write speed and read speed of the ECU 300D are 1 Mbps and 1 Mbps, respectively.

The weight assigned to the number of logical constituent units (banks) (the item “memory bank” in FIG. 6) x7 in the non-volatile memory 302 in the ECU 300 is 20%. The score for item x7 assigned to the ECUs 300B and 300E including a double-bank non-volatile memory 302 is 1. The score for item x7 assigned to the ECUs 300C and 300D including a single-bank non-volatile memory 302 is 0.

Returning to FIG. 5, the selection unit 211 calculates an evaluation value E for each ECU 300 by: E=15x1+15x2+20x3+10x4+10x5+10x6+20x7. This formula for calculating the evaluation value E represents the selection condition. The selection unit 211 selects, as the storage destination (selected ECU 310) of a part of the update data, the ECU 300 having the highest evaluation value E among the ECUs 300 that are candidates of the storage destination of a part of the update data (the target ECU 320 is excluded from the candidates). Note that, while the selection condition is a condition relating to each item among: the processing load of the ECU 300 when the vehicle 10 is in the driven state; the processing load of the ECU 300 when a vehicle occupant is on board the vehicle 10; the security strength of the ECU 300; the communication accessibility of the ECU 300; the free space in the non-volatile memory 302 provided in the ECU 300; the write and read speeds of the non-volatile memory 302; and the number of logical constituent units in the non-volatile memory 302 included in the ECU 300 in this example, there is no limitation to this. The selection condition may be a condition relating to one or more items selected from among: the processing load of the ECU 300 when the vehicle 10 is in the driven state; the processing load of the ECU 300 when a vehicle occupant is on board the vehicle 10; the security strength of the ECU 300; the communication accessibility of the ECU 300; the free space in the non-volatile memory 302 provided in the ECU 300; the write and read speeds of the non-volatile memory 302; and the number of logical constituent units in the non-volatile memory 302 included in the ECU 300.

The notification unit 212 notifies the OTA server 50 of the selected ECU 310 selected by the selection unit 211. For example, the notification unit 212 can notify the OTA server 50 of identification information of the selected ECU 310.

The OTA server 50 splits the update data into the first partial data and the second partial data. The OTA server 50 transmits the first update data including the first partial data and transmits the second update data including the second partial data.

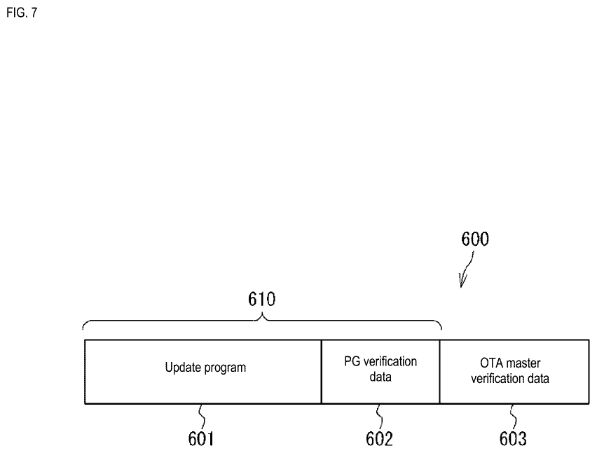

FIG. 7 is a diagram for describing an example of a configuration of the update data. Update data 610 is data to be used in the update of the control program 306 by the target ECU 320. The update data 610 includes an updated program 601 (binary data of updated program in an executable format) and program verification data (hereinafter “PG verification data”) 602. The PG verification data 602 is data to be used in the verification of the updated program 601 by the target ECU 320. The OTA server 50 generates the PG verification data 602 by encrypting a hash value of the updated program 601 using key data. The OTA server 50 generates the update data 610 by combining the updated program 601 and the PG verification data 602.

An update package 600 illustrated in FIG. 7 includes the update data 610 and OTA master verification data 603. The OTA master verification data 603 is data to be used in the verification of the update data 610 by the OTA master 200. The OTA server 50 generates the OTA master verification data 603 by encrypting a hash value of the update data 610 using key data. The OTA server 50 generates the update package 600 by combining the update data 610 and the OTA master verification data 603.

If there is a free space large enough to store the update package 600 in the non-volatile memory 202 in the OTA master 200, the OTA server 50 downloads the update package 600 to the OTA master 200. The OTA master 200 stores the downloaded update package 600 in the non-volatile memory 202. The OTA master 200 decrypts the OTA master verification data 603 included in the update package 600 using the key data 206 stored in the non-volatile memory 202. The OTA master 200 verifies the update data 610 included in the update package 600 by calculating a hash value of the update data 610, and comparing the calculated hash value with a hash value obtained by decrypting the OTA master verification data 603.

If the two hash values match, the OTA master 200 transmits the update data 610 to the target ECU 320. The target ECU 320 stores the received update data 610 in the non-volatile memory 302. The target ECU 320 decrypts the PG verification data 602 included in the update data 610 using the key data 307 stored in the non-volatile memory 302. The target ECU 320 verifies the updated program 601 included in the update data 610 by calculating a hash value of the updated program 601, and comparing the calculated hash value with a hash value obtained by decrypting the PG verification data 602. If the verification of the updated program 601 is successful, or that is, if the two hash values match, the target ECU 320 updates the control program 306 by installing the updated program 601.

If there is no free space large enough to store the update package 600 in the non-volatile memory 202 in the OTA master 200, the selection unit 211 selects the selected ECU 310. The OTA master 200 requests the OTA server 50 to split the update data 610. This request includes information about the selected ECU 310. In other words, the OTA master 200 notifies the OTA server 50 of the selected ECU 310 by requesting the OTA server 50 to split the update data 610.

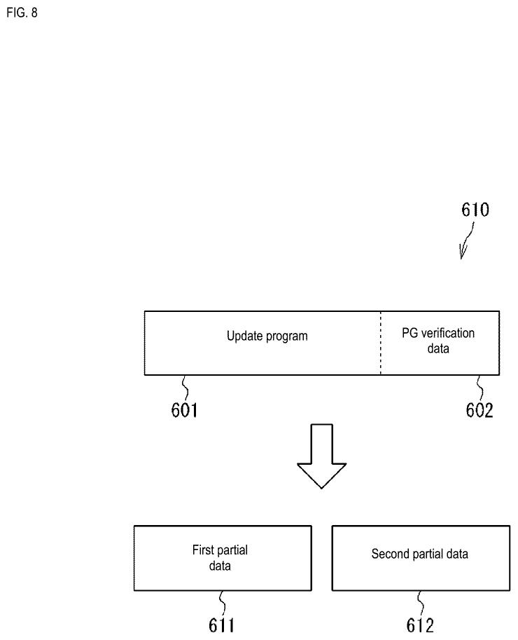

Upon receiving the request to split the update data 610, the OTA server 50 splits the update data 610. FIG. 8 is a diagram describing an example of the splitting of the update data 610. In the present embodiment, the OTA server 50 splits the update data 610 into two parts, first partial data 611 and second partial data 612. However, the update data 610 may be split into three or more pieces of partial data.

The update data 610 is formed from the updated program 601 and the PG verification data 602. The PG verification data 602 is included in the first partial data 611 or the second partial data 612. However, part of the PG verification data 602 may be included in the first partial data 611, and the rest of the PG verification data 602 may be included in the second partial data 612.

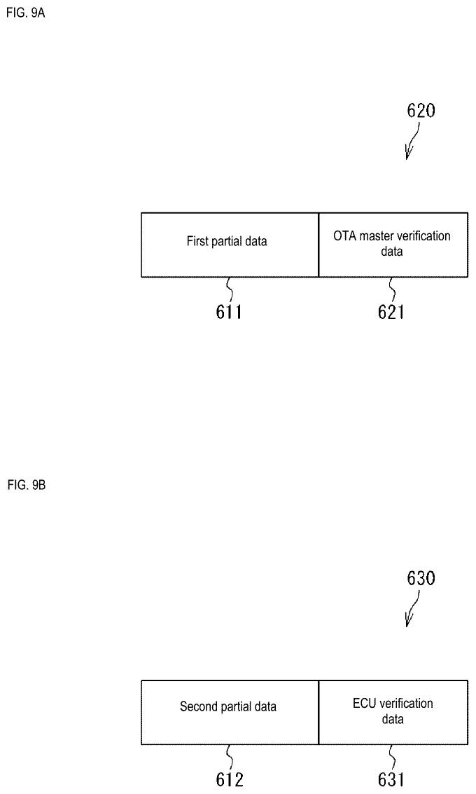

FIG. 9A is a diagram illustrating an example of a configuration of the first update data. First update data 620 illustrated in FIG. 9A includes the first partial data 611 and OTA master verification data 621. The OTA master verification data 621 is data to be used in the verification of the first partial data 611 by the OTA master 200, and is an example of “first verification data”. The OTA server 50 generates the OTA master verification data 621 by encrypting a hash value of the first partial data 611 using key data. The OTA server 50 generates the first update data 620 by combining the first partial data 611 and the OTA master verification data 621.

FIG. 9B is a diagram illustrating an example of a configuration of the second update data. Second update data 630 illustrated in FIG. 9B includes the second partial data 612 and ECU verification data 631. The ECU verification data 631 is data to be used in the verification of the second partial data 612 by the selected ECU 310, and is an example of “second verification data”. The OTA server 50 generates the ECU verification data 631 by encrypting a hash value of the second partial data 612 using key data. The OTA server 50 generates the second update data 630 by combining the second partial data 612 and the ECU verification data 631.

Returning to FIG. 5, the OTA server 50 transmits the first update data 620 to the OTA master 200. The first reception unit 213 of the OTA master 200 receives the first update data 620 transmitted from the OTA server 50. The first storage unit 214 stores the first update data 620 received by the first reception unit 213.

The first verification unit 215 decrypts the OTA master verification data 621 included in the first update data 620 using the key data 206 stored in the non-volatile memory 202. The first verification unit 215 verifies the first partial data 611 included in the first update data 620 by calculating a hash value of the first partial data 611, and comparing the calculated hash value with a hash value obtained by decrypting the OTA master verification data 621.

If the verification of the first partial data 611 is successful, or that is, if the two hash values match, the first transmission unit 216 transmits the first partial data 611 to the target ECU 320.

The OTA server 50 transmits the second update data 630 to the OTA master 200. The OTA master 200 transmits the received second update data 630 to the selected ECU 310. The second reception unit 311 of the selected ECU 310 receives the second update data 630 transmitted from the OTA server 50. The second storage unit 312 stores the second update data 630 received by the second reception unit 311.

The second verification unit 313 decrypts the ECU verification data 631 included in the second update data 630 using the key data 307 stored in the non-volatile memory 302. The second verification unit 313 verifies the second partial data 612 included in the second update data 630 by calculating a hash value of the second partial data 612, and comparing the calculated hash value with a hash value obtained by decrypting the ECU verification data 631.

If the verification of the second partial data 612 is successful, or that is, if the two hash values match, the second transmission unit 314 transmits the second partial data 612 to the target ECU 320.

The third reception unit 321 of the target ECU 320 receives the first partial data 611 transmitted from the OTA master 200. The third storage unit 322 stores the received first partial data 611. The third reception unit 321 receives the second partial data 612 transmitted from the selected ECU 310. The third storage unit 322 stores the received second partial data 612.

The generation unit 323 generates (reconstructs) the update data 610 by combining the first partial data 611 and the second partial data 612 received by the third reception unit 321.

The third verification unit 324 decrypts the PG verification data 602 included in the update data 610 using the key data 307 stored in the non-volatile memory 302. The third verification unit 324 verifies the updated program 601 included in the update data 610 by calculating a hash value of the updated program 601, and comparing the calculated hash value with a hash value obtained by decrypting the PG verification data 602.

If the verification of the updated program 601 is successful, or that is, if the two hash values match, the update unit 325 updates the control program 306 by installing the updated program 601.

### Operations of Program-Updating System

Operations of the program-updating system according to the present embodiment will be described in the following.

### Memory-Free-Space Check Processing

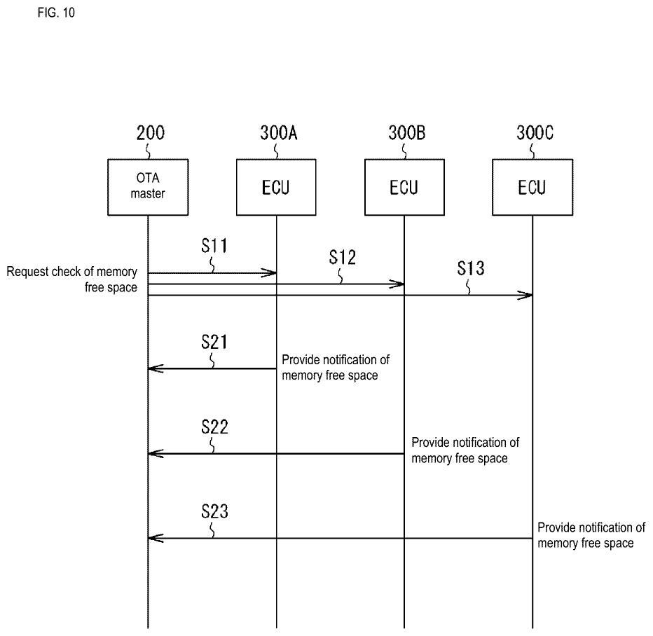

In order to collect information for selecting the storage destination of a part of the update data, the OTA master 200 executes memory-free-space check processing for checking the free space in the non-volatile memory 302 in each of the ECUs 300A, 300B, 300C, 300D, and 300E. FIG. 10 is a sequence diagram for describing an example of the memory-free-space check processing.

The OTA master 200 transmits a request to check the free space in the non-volatile memory 302 to each of the ECUs 300A, 300B, 300C, 300D, and 300E (steps S11 to S13). Upon receiving the request, each of the ECUs 300A, 300B, 300C, 300D, and 300E acquires information indicating the free space in the non-volatile memory 302, and notifies the OTA master 200 of the free space in the non-volatile memory 302 by transmitting this information (steps S21 to S23). The OTA master 200 acquires the free space in the non-volatile memory 302 in each of the ECUs 300A, 300B, 300C, 300D, and 300E by receiving the information transmitted from each of the ECUs 300A, 300B, 300C, 300D, and 300E.

The OTA master 200 transmits the above-described request for checking the free space in the non-volatile memory 302 at regular intervals, for example. Thus, the free space in the non-volatile memory 302 in each of the ECUs 300A, 300B, 300C, 300D, and 300E is updated on a regular basis, and the OTA master 200 can select the storage destination of a part of the update data.

### Split Download Processing

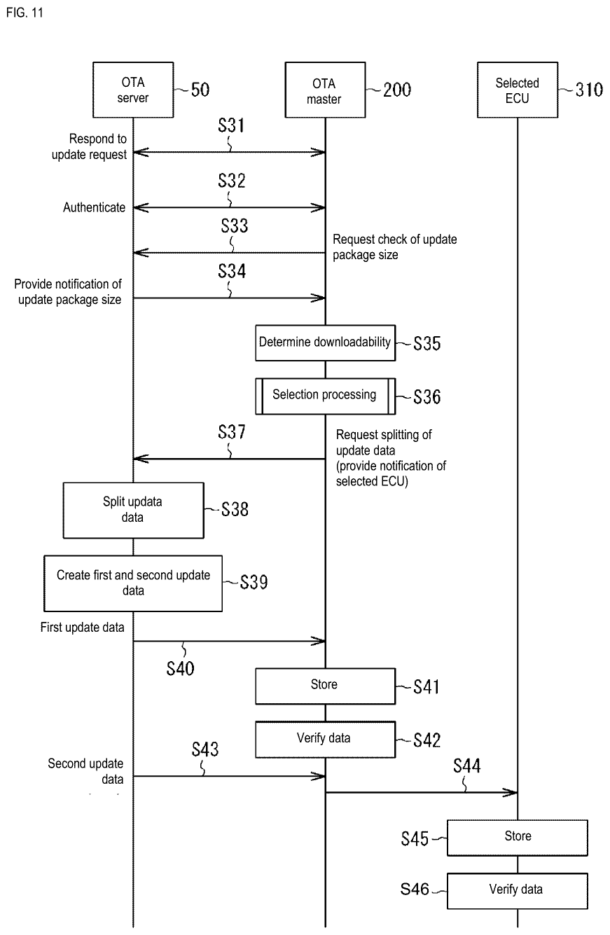

If there is no free space large enough to store the update package 600 in the non-volatile memory 202 in the OTA master 200 as described above, the program update system executes split download processing for splitting and downloading the update data. FIG. 11 is a sequence diagram for describing an example of the split download processing.

When a new version of the control program 306 is released for a given ECU 300, update data 610 including an updated program 601 corresponding to the version is stored in the OTA server 50. In this case, the OTA server 50 transmits a request to update the control program 306 to the OTA master 200. Upon receiving the request to update the control program 306, the OTA master 200 transmits a response to the OTA server 50 (step S31).

Next, the OTA master 200 transmits, to the OTA server 50, authentication data for verifying the authenticity of the OTA master 200, and the OTA server 50 performs authentication. If the authentication is successful, the OTA server 50 notifies the OTA master 200 that the authentication was successful (step S32).

The OTA master 200 transmits, to the OTA server 50, a request to check the size of the update package 600 (step S33). Upon receiving the request to check the size of the update package 600, the OTA server 50 notifies the OTA master 200 of the size of the update package 600 (step S34).

The OTA master 200 compares the free space in the non-volatile memory 202 and the size of the update package 600, and determines whether or not the update package 600 can be stored in the non-volatile memory 202, i.e., whether or not the update package 600 is downloadable (step S35). If the update package 600 is downloadable, the OTA master 200 downloads the update package 600 from the OTA server 50 as described above. Note that, in FIG. 11, the processing in the case in which the update package 600 is downloadable is omitted, and only the processing in the case in which the update package 600 is not downloadable is illustrated.

Upon determining that the update package 600 is not downloadable, the OTA master 200 executes selection processing for selecting the storage destination of a part of the update data (step S36).

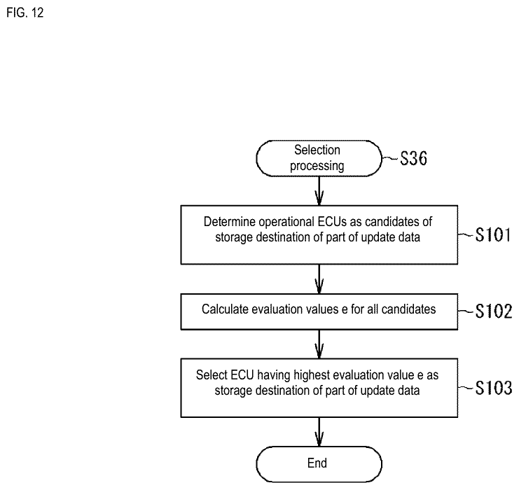

FIG. 12 is a flowchart illustrating an example of the selection processing. The processor 201 of the OTA master 200 checks the state of the power sources in the vehicle 10, and identifies operational ECUs 300 (ECUs 300 to which electrically is being supplied). If the ignition (IG) of the vehicle 10 is on, electricity is supplied to all ECUs 300, and all ECUs 300 are operational. If the IG of the vehicle 10 is off, electricity is supplied only to ECUs 300 that are driven by a battery power source, and these ECUs 300 are operational. The processor 201 determines operational ECUs 300 other than the target ECU 320 as candidates of the storage destination of a part of the update data (step S101).

Next, the processor 201 calculates evaluation values E for all candidates using the above-described formula of evaluation value E (step S102). The processor 201 selects the candidate having the highest evaluation value E as the storage destination (selected ECU 310) of a part of the update data (step S103). This concludes the selection processing.

Returning to FIG. 11, the OTA master 200 transmits, to the OTA server 50, a request to split the update data (step S37). The split request includes identification information of the selected ECU 310. Note that the OTA master 200 may notify the OTA server 50 of the free space in the non-volatile memory 302 in the selected ECU 310, rather than the identification information of the selected ECU 310.

Upon receiving the request, the OTA server 50 splits the update data 610 into sizes corresponding to the OTA master 200 and the selected ECU 310 (step S38). The OTA server 50 creates first update data 620 by generating OTA master verification data 621 and combining first partial data 611 and the OTA master verification data 621. The OTA server 50 creates second update data 630 by generating ECU verification data 631 and combining second partial data 612 and the ECU verification data 631 (step S39).

The OTA server 50 transmits the first update data 620 to the OTA master 200 (step S40). Upon receiving the first update data 620, the OTA master 200 stores the first update data 620 in the non-volatile memory 202 (step S41). The OTA master 200 verifies the first partial data 611 included in the first update data 620 using the OTA master verification data 621 (step S42).

The OTA server 50 transmits the second update data 630 to the OTA master 200 (step S43). Upon receiving the second update data 630, the OTA master 200 transfers the received second update data 630 to the selected ECU 310 (step S44). Upon receiving the second update data 630, the selected ECU 310 stores the second update data 630 in the non-volatile memory 302 (step S45). The selected ECU 310 verifies the second partial data 612 included in the second update data 630 using the ECU verification data 631 (step S46). This concludes the split download processing.

### Program Update Processing

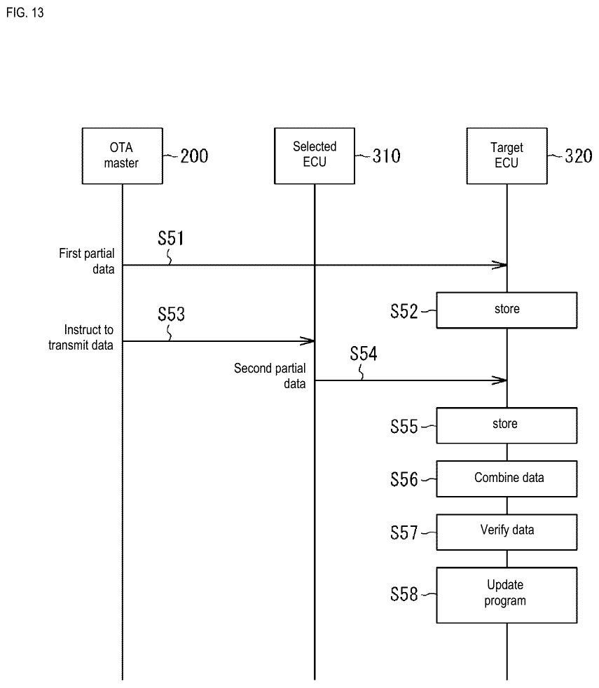

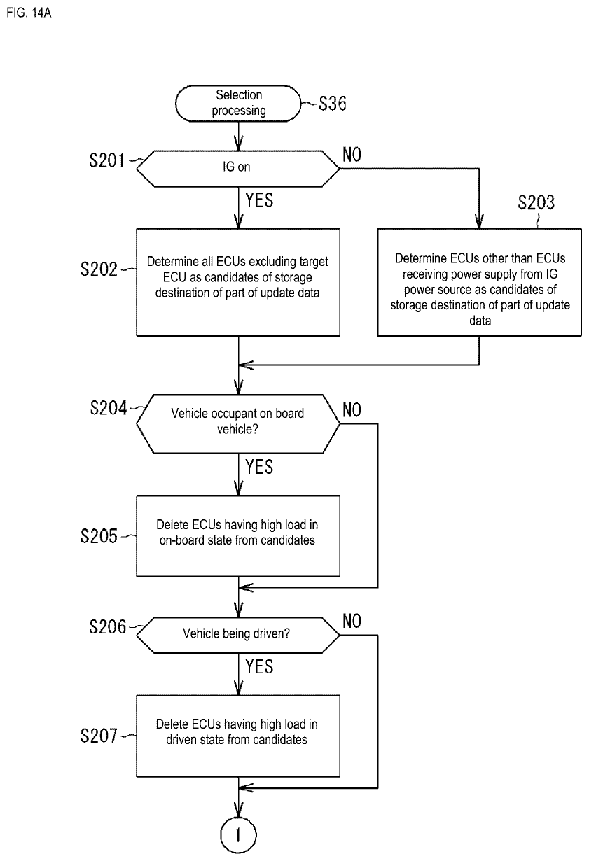

After the split download processing, the program update system executes program update processing for updating the control program of the target ECU 320. FIG. 13 is a sequence diagram for describing an example of the program update processing.

Having successfully verified the first partial data 611, the OTA master 200 transmits the first partial data 611 to the target ECU 320 (step S51). Upon receiving the first partial data 611, the target ECU 320 stores the first partial data 611 in the non-volatile memory 302 (step S52).

The OTA master 200 transmits, to the selected ECU 310, an instruction to transmit the second partial data 612 (step S53). Upon receiving the instruction to transmit the second partial data 612, the selected ECU 310 having successfully verified the second partial data 612 transmits the second partial data 612 to the target ECU 320 (step S54). Upon receiving the second partial data 612, the target ECU 320 stores the second partial data 612 in the non-volatile memory 302 (step S55).

The target ECU 320 reconstructs the update data 610 by combining the received first partial data 611 and the received second partial data 612 (step S56). The target ECU 320 verifies the updated program 601 included in the update data 610 using the PG verification data 602 (step S57). When the verification is successful, the target ECU 320 updates the control program 306 by installing the updated program 601 into the non-volatile memory 302 (step S58). This concludes the program update processing.

### Modification

The selection unit 211 may select the selected ECU 310 by sequentially determining, with respect to the plurality of conditions included in the selection condition, one or more ECUs 300 that meet the concerned condition from among the ECUs 300B, 300C, 300D, and 300E.

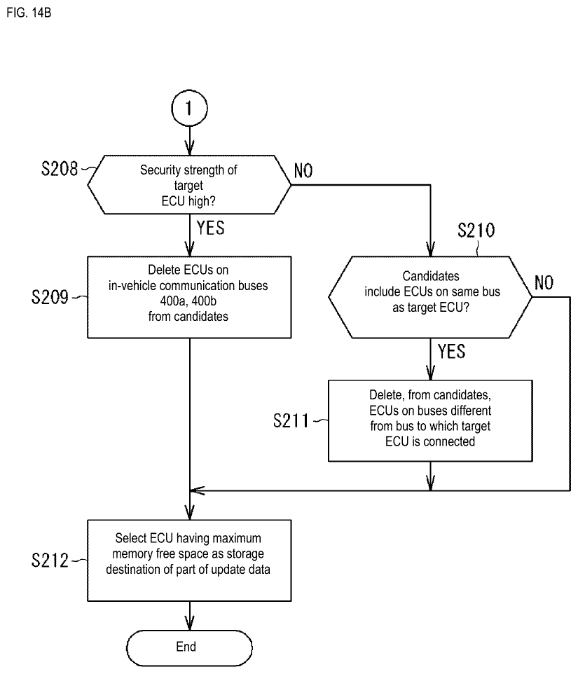

FIGS. 14A and 14B are flowcharts illustrating an example of selection processing according to the present modification. In the present modification, the processor 201 of the OTA master 200 executes the following selection processing (step S36).

The processor 201 determines whether or not the IG of the vehicle 10 is on (step S201). If the IG of the vehicle 10 is on (YES in step S201), the processor 201 determines all ECUs 300 excluding the target ECU 320 as candidates of the storage destination of a part of the update data 610 (step S202). If the IG of the vehicle 10 is off (NO in step S201), the processor 201 determines ECUs 300 other than those receiving power supply from an IG power source (i.e., determines ECUs 300 that receive power supply from the battery power source) as candidates of the storage destination of a part of the update data 610 (step S203). The processor 201 shifts the processing to step S204 after step S202 or S203.

The processor 201 determines whether or not there is a vehicle occupant on board the vehicle 10 (step S204). If there is a vehicle occupant on board the vehicle 10 (YES in step S204), the processor 201 deletes, from the candidates, ECUs 300 having a high processing load in the on-board state (step S205). The processor 201 shifts the processing to step S206 after step S205. If no vehicle occupant is on board the vehicle 10 (NO in step S204), the processor 201 also shifts the processing to step S206.

The processor 201 determines whether or not the vehicle 10 is being driven (is traveling) (step S206). If the vehicle 10 is being driven (YES in step S206), the processor 201 deletes, from the candidates, ECUs 300 having a high processing load in the driven state (step S207). The processor 201 shifts the processing to step S208 after step S207. If the vehicle 10 is not being driven, or that is, if the vehicle 10 is stationary (NO in step S206), the processor 201 also shifts the processing to step S208.

The processor 201 determines whether the security strength of the target ECU 320 is high or low (step S208). If the target ECU 320 is connected to the in-vehicle communication bus 400A or 400B, the processor 201 determines that the security strength of the target ECU 320 is high (YES in step S208). In this case, the processor 201 deletes, from the candidates, the ECUs 300 on the in-vehicle communication buses 400A and 400B (step S209). The processor 201 shifts the processing to step S212 after step S209.

If the target ECU 320 is connected to the vehicle-to-external communication bus 400C, the processor 201 determines that the security strength of the target ECU 320 is low (NO in step S208). In this case, the processor 201 determines whether or not one or more ECUs 300 connected to the same bus as the target ECU 320 are included in the candidates (step S210). If one or more ECUs 300 connected to the same bus as the target ECU 320 are included in the candidates (YES in step S210), the processor 201 deletes ECUs 300 that are connected to buses that are different from the vehicle-to-external communication bus 400C, to which the target ECU 320 is connected (step S211). The processor 201 shifts the processing to step S212 after step S211. If ECUs 300 connected to the same bus as the target ECU 320 are not included in the candidates (NO in step S210), the processor 201 also shifts the processing to step S212.

The processor 201 selects, as the storage destination of a part of the update data 610, the ECU 300 having the maximum free space in the non-volatile memory 302 among the candidates (step S212). This concludes the selection processing.

### Other Modifications

In the above-described embodiment, the integrated ECU 200 is the OTA master; however, there is no limitation to this. An individual ECU 300 may be the OTA master.

In the above-described embodiment, the OTA master 200 selects the storage destination of a part of the update data 610; however, there is no limitation to this. For example, it may be the OTA server 50 that selects the storage destination of a part of the update data 610. In this case, the OTA master 200 may notify the OTA server 50 of the free space in the non-volatile memory 302 in each of the ECUs 300A, 300B, 300C, 300D, and 300E.

### Effects of Embodiment

An on-board system 100 includes: a target ECU 320 (target on-board apparatus) that is an ECU 300 in which a control program 306 is to be currently updated; a plurality of ECUs 300B, 300C, 300D, and 300E (non-target on-board apparatuses) that are each an ECU 300 in which the control program 306 is not to be currently updated; and an OTA master 200 (update control apparatus) that controls the update of the control program 306 in the target ECU 320. The OTA master 200 includes: a first reception unit 213; a first storage unit 214; and a first transmission unit 216. The first reception unit 213 receives first partial data 611 from an OTA server 50 (external apparatus) that is disposed outside a vehicle 10. The first partial data 611 is partial data of update data 610 to be used in the update of the control program 306. The first storage unit 214 stores the first partial data 611 received by the first reception unit 213. The first transmission unit 216 transmits, to the target ECU 320, the first partial data 611 stored in the first storage unit 214. A selected ECU 310 (selected on-board apparatus) selected from among the plurality of ECUs 300B, 300C, 300D, and 300E includes: a second reception unit 311; a second storage unit 312; and a second transmission unit 314. The second reception unit 311 receives second partial data 612 from the OTA server 50. The second partial data 612 is partial data of the update data 610 and is data that is different from the first partial data 611. The second storage unit 312 stores the second partial data 612 received by the second reception unit 311. The second transmission unit 314 transmits, to the target ECU 320, the second partial data 612 stored in the second storage unit 312. The target ECU 320 includes: a third reception unit 321; a generation unit 323; and an update unit 325. The third reception unit 321 receives the first partial data 611 from the OTA master 200 and receives the second partial data 612 from the selected ECU 310. The generation unit 323 generates the update data 610 by combining the first partial data 611 and the second partial data 612 received by the third reception unit 321. The update unit 325 updates the control program 306 using the update data 610 generated by the generation unit 323. Thus, because a part of the update data 610 is stored in the OTA master 200 and another part of the update data 610 is stored in the selected ECU 310, the update data 610 can be downloaded without moving data in a non-volatile memory 202 of the OTA master 200 to a different location even if there is not enough free space in the non-volatile memory 202 of the OTA master 200.

The selected ECU 310 may be selected from among the plurality of ECUs 300B, 300C, 300D, and 300E based on a selection condition for each of the plurality of ECUs 300A, 300B, 300C, 300D, and 300E. Thus, the selected ECU 310 can be selected from the ECUs 300B, 300C, 300D, and 300E in accordance with the selection condition.

The selection condition may be a condition relating to at least one of: a processing load of the ECU 300 when the vehicle 10 is in a driven state; a processing load of the ECU 300 when a vehicle occupant is on board the vehicle 10; a security strength of the ECU 300; a communication accessibility of the ECU 300; the free space in a non-volatile memory 302 provided in the ECU 300; write and read speeds of the non-volatile memory 302 provided in the ECU 300; and the number of logical constituent units in the non-volatile memory 302 included in the ECU 300. Thus, the selected ECU 310 can be selected appropriately based on the above-described conditions.

The on-board system 100 may include an external-communication apparatus 500 that can communicate with the OTA server 50. The security strength of an ECU 300 that is connected to a same bus 400C as the external-communication apparatus 500 may be lower than the security strength of ECUs 300 that are connected to buses 400A and 400B that are different from the bus 400C, to which the external-communication apparatus 500 is connected. Thus, the selected ECU 310 can be selected appropriately in accordance with buses to which the ECUs 300 are connected in the on-board system 100.

The communication accessibility of an ECU 300 that is connected to the same bus 400A as the target ECU 320 may be higher than the communication accessibility of ECUs 300 that are connected to buses 400B and 400C that are different from the bus 400A, to which the target ECU 320 is connected. Thus, the selected ECU 310 can be selected appropriately in accordance with buses to which the ECUs 300 are connected in the on-board system 100.

The number of logical constituent units in the non-volatile memory 302 included in the ECU 300 may include a case in which the ECU 300 includes a single-bank non-volatile memory 302 and a case in which the ECU 300 includes a double-bank non-volatile memory 302. Thus, the selected ECU 310 can be selected appropriately in accordance with whether non-volatile memories 302 included in the ECUs 300 are single-bank memories or double-bank memories.

The OTA master 200 may include: a selection unit 211; and a notification unit 212. The selection unit 211 selects the selected ECU 310 from among the plurality of ECUs 300B, 300C, 300D, and 300E based on the selection condition. The notification unit 212 notifies the OTA server 50 of the selected ECU 310 selected by the selection unit 211. Thus, the OTA master 200, which is installed in the vehicle 10, can select the selected ECU 310.

The selection unit 211 may assign, to each of the ECUs 300B, 300C, 300D, and 300E, a score for at least one item among: the processing load of the ECU 300 when the vehicle 10 is in the driven state; the processing load of the ECU 300 when a vehicle occupant is on board the vehicle 10; the security strength of the ECU 300; the communication accessibility of the ECU 300; the free space in the non-volatile memory 302 provided in the ECU 300; the write and read speeds of the non-volatile memory 302 provided in the ECU 300; and the number of logical constituent units in the non-volatile memory 302 included in the ECU 300, and select the selected ECU 310 from among the ECUs 300B, 300C, 300D, and 300E based on the score. Thus, the ECUs 300B, 300C, 300D, and 300E can be quantitatively evaluated with respect to the above-described items, and the selected ECU 310 can be selected appropriately in accordance with the result of the evaluation.

The selection unit 211 may assign a weight to each of a plurality of items consisting of the processing load of the ECU 300 when the vehicle 10 is in the driven state; the processing load of the ECU 300 when a vehicle occupant is on board the vehicle 10; the security strength of the ECU 300; the communication accessibility of the ECU 300; the free space in the non-volatile memory 302 provided in the ECU 300; the write and read speeds of the non-volatile memory 302 provided in the ECU 300; and the number of logical constituent units in the non-volatile memory 302 included in the ECU 300, and select the selected ECU 310 from among the ECUs 300B, 300C, 300D, and 300E based on a result obtained by multiplying the weight by the score. Thus, the ECUs 300B, 300C, 300D, and 300E can be quantitatively evaluated in accordance with the degrees of importance of the above-described items, and the selected ECU 310 can be selected appropriately in accordance with the result of the evaluation.

The selection condition may include a plurality of conditions relating to a plurality of items selected from among: the processing load of the ECU 300 when the vehicle 10 is in the driven state; the processing load of the ECU 300 when a vehicle occupant is on board the vehicle 10; the security strength of the ECU 300; the communication accessibility of the ECU 300; the free space in the non-volatile memory 302 provided in the ECU 300; the write and read speeds of the non-volatile memory 302 provided in the ECU 300; and the number of logical constituent units in the non-volatile memory 302 included in the ECU 300. The selection unit 211 may select the selected ECU 310 by sequentially determining, with respect to the plurality of conditions, one or more ECUs 300 that meet the concerned condition from among the ECUs 300B, 300C, 300D, and 300E. Thus, by sequentially determining ECUs 300 that meet the plurality of conditions, ECUs 300 that are candidates of the selected ECU 310 can be narrowed down.

The first reception unit 213 may receive, from the OTA server 50, first update data 620 that includes the first partial data 611 and OTA master verification data 621 (first verification data) for verifying the first partial data 611. The OTA master 200 may include a first verification unit 215. The first verification unit 215 verifies the first partial data 611 included in the first update data 620 using the OTA master verification data 621 included in the first update data 620. The first transmission unit 216 may transmit the first partial data 611 to the target ECU 320 if the verification of the first partial data 611 by the first verification unit 215 is successful. The second reception unit 311 may receive, from the OTA server 50, second update data 630 that includes the second partial data 612 and ECU verification data 631 (second verification data) for verifying the second partial data 612. The selected ECU 310 may include a second verification unit 313. The second verification unit 313 verifies the second partial data 612 included in the second update data 630 using the ECU verification data 631 included in the second update data 630. The second transmission unit 314 may transmit the second partial data 612 to the target ECU 320 if the verification of the second partial data 612 by the second verification unit 313 is successful. Thus, the first partial data 611 and the second partial data 612 can be verified individually.

The update data 610 may include an updated program 601 that is an updated version of the program, and PG verification data 602 to be used to verify the updated program 601. The PG verification data 602 may be included in the first partial data 611 or the second partial data 612. Thus, the updated program 601 included in the update data 610 obtained by combining the first partial data 611 and the second partial data 612 can be verified.

### Supplement

An update control program for use in an update control apparatus that controls the update of a program in a target on-board apparatus that is an on-board apparatus in which the program is to be currently updated, wherein the update control program causes a computer to function as: a reception unit that receives, from an external apparatus that is disposed outside a vehicle, first partial data that is partial data of update data to be used in the update of the program; a storage unit in which the first partial data received by the reception unit is stored; and a transmission unit that transmits the first partial data stored in the storage unit to the target on-board apparatus so that the target on-board apparatus can generate the update data by combining the first partial data and second partial data transmitted from a selected on-board apparatus, the second partial data being partial data of the update data and being different from the first partial data, and the selected on-board apparatus is an on-board apparatus in which the second partial data transmitted from the external apparatus is stored.

### Additional Note

The embodiments disclosed herein are examples in every way and are non-limiting. The scope of the present disclosure is not limited to the above-described embodiments; that is, the scope of the present disclosure is indicated by the claims, and includes all modifications that are within the meaning and scope of equivalents of the claims.

1. An on-board system comprising:
a target on-board apparatus that is an on-board apparatus in which a program is to be currently updated;
a plurality of non-target on-board apparatuses that are each an on-board apparatus in which the program is not to be currently updated; and
an update control apparatus that controls the update of the program in the target on-board apparatus,
wherein the update control apparatus includes:
a first reception unit that receives, from an external apparatus that is disposed outside a vehicle, first partial data that is partial data of update data to be used in the update of the program;
a first storage unit in which the first partial data received by the first reception unit is stored; and
a first transmission unit that transmits, to the target on-board apparatus, the first partial data stored in the first storage unit,
a selected on-board apparatus selected from among the plurality of non-target on-board apparatuses includes:
a second reception unit that receives, from the external apparatus, second partial data that is partial data of the update data and that is different from the first partial data;
a second storage unit in which the second partial data received by the second reception unit is stored; and
a second transmission unit that transmits, to the target on-board apparatus, the second partial data stored in the second storage unit, and
the target on-board apparatus includes:
a third reception unit that receives the first partial data from the update control apparatus and receives the second partial data from the selected on-board apparatus;
a generation unit that generates the update data by combining the first partial data and the second partial data received by the third reception unit; and
an update unit that updates the program using the update data generated by the generation unit.

2. The on-board system according to claim 1, wherein the selected on-board apparatus is selected from among the plurality of non-target on-board apparatuses based on a selection condition for each of the plurality of on-board apparatuses.

3. The on-board system according to claim 2, wherein the selection condition is a condition relating to at least one of: a processing load of the on-board apparatus when the vehicle is in a driven state; a processing load of the on-board apparatus when a vehicle occupant is on board the vehicle; a security strength of the on-board apparatus; a communication accessibility of the on-board apparatus; a free space in a storage unit provided in the on-board apparatus; write and read speeds of the storage unit; and the number of logical constituent units in the storage unit included in the on-board apparatuses.

4. The on-board system according to claim 3 further including;
an external-communication apparatus that can communicate with the external apparatus,
wherein the security strength of an on-board apparatus that is connected to a same bus as the external-communication apparatus is lower than the security strength of an on-board apparatus that is connected to a bus that is different from the bus to which the external-communication apparatus is connected.

5. The on-board system according to claim 3, wherein the communication accessibility of an on-board apparatus that is connected to a same bus as the target on-board apparatus is higher than the communication accessibility of an on-board apparatus that is connected to a bus that is different from the bus to which the target on-board apparatus is connected.

6. The on-board system according to claim 3, wherein the number of logical constituent units in the storage unit included in the on-board apparatus includes a case in which the on-board apparatus includes a single-bank non-volatile memory and a case in which the on-board apparatus includes a double-bank non-volatile memory.

7. The on-board system according to claim 3,
wherein the update control apparatus includes:
a selection unit that selects the selected on-board apparatus from among the plurality of non-target on-board apparatuses based on the selection condition; and
a notification unit that notifies the external apparatus of the selected on-board apparatus selected by the selection unit.

8. The on-board system according to claim 7,
wherein the selection unit
assigns, to each of the plurality of non-target on-board apparatuses, a score for at least one item among: the processing load of the on-board apparatus when the vehicle is in the driven state; the processing load of the on-board apparatus when a vehicle occupant is on board the vehicle; the security strength of the on-board apparatus; the communication accessibility of the on-board apparatus; the free space in the storage unit provided in the on-board apparatus; the write and read speeds of the storage unit; and the number of logical constituent units in the storage unit included in the on-board apparatus, and
selects the selected on-board apparatus from among the plurality of the non-target on-board apparatuses based on the score.

9. The on-board system according to claim 8,
wherein the selection unit
assigns a weight to each of a plurality of items consisting of: the processing load of the on-board apparatus when the vehicle is in the driven state; the processing load of the on-board apparatus when a vehicle occupant is on board the vehicle; the security strength of the on-board apparatus; the communication accessibility of the on-board apparatus; the free space in the storage unit provided in the on-board apparatus; the write and read speeds of the storage unit; and the number of logical constituent units in the storage unit included in the on-board apparatus, and
selects the selected on-board apparatus from among the plurality of the non-target on-board apparatuses based on a result obtained by multiplying the weight by the score.

10. The on-board system according to claim 7,
wherein the selection condition includes a plurality of conditions relating to a plurality of items selected from among: the processing load of the on-board apparatus when the vehicle is in the driven state; the processing load of the on-board apparatus when a vehicle occupant is on board the vehicle; the security strength of the on-board apparatus; the communication accessibility of the on-board apparatus; the free space in the storage unit provided in the on-board apparatus; the write and read speeds of the storage unit; and the number of logical constituent units in the storage unit included in the on-board apparatus, and
the selection unit selects the selected on-board apparatus by sequentially determining, with respect to the plurality of conditions, one or more on-board apparatuses that meet the concerned condition from among the plurality of non-target on-board apparatuses.

11. The on-board system according to claim 1,
wherein the first reception unit receives, from the external apparatus, first update data that includes the first partial data and first verification data for verifying the first partial data,
the update control apparatus includes a first verification unit that verifies the first partial data included in the first update data using the first verification data included in the first update data,
the first transmission unit transmits the first partial data to the target on-board apparatus if the verification of the first partial data by the first verification unit is successful,
the second reception unit receives, from the external apparatus, second update data that includes the second partial data and second verification data for verifying the second partial data,
the selected on-board apparatus includes a second verification unit that verifies the second partial data included in the second update data using the second verification data included in the second update data, and
the second transmission unit transmits the second partial data to the target on-board apparatus if the verification of the second partial data by the second verification unit is successful.

12. The on-board system according to claim 1,
wherein the update data includes an updated program that is an updated version of the program, and program verification data to be used to verify the updated program, and
the program verification data is included in the first partial data or the second partial data.

13. An update control apparatus that controls the update of a program in a target on-board apparatus that is an on-board apparatus in which the program is to be currently updated, the update control apparatus comprising:
a reception unit that receives, from an external apparatus that is disposed outside a vehicle, first partial data that is partial data of update data to be used in the update of the program;
a storage unit in which the first partial data received by the reception unit is stored; and
a transmission unit that transmits the first partial data stored in the storage unit to the target on-board apparatus so that the target on-board apparatus can generate the update data by combining second partial data transmitted from a selected on-board apparatus and the first partial data, the second partial data being partial data of the update data and being different from the first partial data,
wherein the selected on-board apparatus is an on-board apparatus in which the second partial data transmitted from the external apparatus is stored.

14. A program update control method executed by an update control apparatus that controls the update of a program in a target on-board apparatus that is an on-board apparatus in which the program is to be currently updated, the program update control method comprising:
a step in which the update control apparatus receives, from an external apparatus that is disposed outside a vehicle, first partial data that is partial data of update data to be used in the update of the program;
a step in which the update control apparatus stores the received first partial data therein; and
a step in which the update control apparatus transmits the stored first partial data to the target on-board apparatus so that the target on-board apparatus can generate the update data by combining second partial data transmitted from a selected on-board apparatus and the first partial data, the second partial data being partial data of the update data and being different from the first partial data,
wherein the selected on-board apparatus is an on-board apparatus in which the second partial data transmitted from the external apparatus is stored.

15. The on-board system according to claim 4,
wherein the update control apparatus includes:
a selection unit that selects the selected on-board apparatus from among the plurality of non-target on-board apparatuses based on the selection condition; and
a notification unit that notifies the external apparatus of the selected on-board apparatus selected by the selection unit.

16. The on-board system according to claim 5,
wherein the update control apparatus includes:
a selection unit that selects the selected on-board apparatus from among the plurality of non-target on-board apparatuses based on the selection condition; and
a notification unit that notifies the external apparatus of the selected on-board apparatus selected by the selection unit.

17. The on-board system according to claim 6,
wherein the update control apparatus includes:
a selection unit that selects the selected on-board apparatus from among the plurality of non-target on-board apparatuses based on the selection condition; and
a notification unit that notifies the external apparatus of the selected on-board apparatus selected by the selection unit.
